(19) United States
(12) Patent Application Publication
(10) Pub. No.: US 2024/0011907 A1
(43) Pub. Date: Jan. 11, 2024

(54) MICROPLASTIC ANALYSIS METHOD, ANALYSIS DEVICE FOR SAME, MICROPLASTIC DETECTION DEVICE, AND MICROPLASTIC DETECTION METHOD

(71) Applicant: HORIBA TECHNO SERVICE Co., Ltd., Kyoto-shi, Kyoto (JP)

(72) Inventor: Yuichi KITAGAWA, Kyoto-shi, Kyoto (JP)

(21) Appl. No.: 18/252,910

(22) PCT Filed: Nov. 25, 2021
(86) PCT No.: PCT/JP2021/043155

§ 371 Date: May 15, 2023

(30) Foreign Application Priority Data
Nov. 27, 2020 (JP) 2020-197278

(51) Int. Cl. G01N 21/64; G01N 21/65

(52) U.S. Cl. CPC G01N 21/643; G01N 21/65

(57) ABSTRACT

Staining a microplastic in a sample W with phosphor; irradiating the sample with fluorescence excitation light and detecting fluorescent light emitted from the phosphor; specifying a position of the microplastic in the sample by the fluorescent light; irradiating the specified position with Raman excitation light and detecting Raman scattered light, and analyzing the microplastic at the position on a basis of the Raman scattered light.

### TECHNICAL FIELD

The present invention relates to a microplastic analysis method and the like using Raman scattered light.

### BACKGROUND ART

As described in Non Patent Literature 1, Raman spectroscopy can be used for qualitative analysis of microplastics. Measurement by Raman spectroscopy has very high spatial resolution; therefore, for example, if sand of a coast containing microplastics is used as a sample, and if the sample is subjected to Raman analysis by using a Raman microscope or the like, it is possible to detect even microplastics of 1 μm or less and to specify the types of the microplastics.

However, because such fine microplastics are extremely difficult to identify with naked eyes or a normal optical image, it is impossible to specify the positions of microplastics, and the entire sample has to be subjected to mapping measurement using Raman. Therefore, depending on the area of the measurement region of a sample, it may take a long time of several hours to several days in some cases. In addition, heat due to laser application for a long time is accumulated, which can cause a problem that the microplastics are burned or melted.

### CITATION LIST

### Non Patent Literature

Non Patent Literature 1: NUMATA Tomoko & YAMAUCHI Susumu, Feature Article: Microplastics related activities in HORIBA group Japan.
https://www.horiba.com/uploads/media/R54J_12_061_03.pdf

### SUMMARY OF THE INVENTION

### Technical Problem

The present invention has been made to solve the above-described issues, and a main desired object of the present invention is to make it possible to analyze microplastics contained in a sample having a certain area, in a short time while using Raman spectroscopy.

### Solution to Problem

Specifically, a microplastic analysis method according to the present invention is characterized in including: staining a microplastic in a sample with phosphor; irradiating the sample with fluorescence excitation light and detecting fluorescent light emitted from the phosphor; specifying a position of the microplastic in the sample by the fluorescent light; irradiating the specified position with Raman excitation light and detecting Raman scattered light; and analyzing the microplastic at the specified position on a basis of the Raman scattered light.

By such a method, it is possible to detect, using fluorescent light, even a microplastic on the order of 500 nm, which cannot be detected by a conventional optical image or naked eyes; therefore, the position of a microplastic in the sample is first specified, and, by irradiating only the specified position with Raman excitation light, it is possible to perform Raman analysis of the composition, type, and the like of the microplastic at the specified position.

Therefore, mapping measurement or the like by Raman over the entire sample is unnecessary, and Raman analysis only needs to be performed at a necessary part, so that the composition, type, and the like of the microplastic contained in the sample can be quickly analyzed.

Examples of a specific method of staining the microplastic includes a method in which the staining a microplastic in a sample with phosphor includes: immersing the sample in a staining liquid in which the phosphor is dissolved in a predetermined solvent; then washing the sample with a cleaning liquid that removes the phosphor attached to a component other than the microplastic.

In order to generate high-intensity fluorescent light in a short time, the phosphor is preferably Nile Red, and the solvent is preferably toluene. In this case, in order to wash and remove the phosphor from substances in the sample other than the microplastic, it is preferable to use ethanol, methanol, or water as the washing liquid.

In order to reliably detect only the fluorescent light, it is only necessary to provide an optical filter that transmits the fluorescent light and blocks the fluorescence excitation light.

When the wavelength of the Raman excitation light is set to a wavelength that cannot excite the phosphor, an influence of fluorescent light in Raman analysis can be eliminated.

The present invention is a microplastic analysis device for a microplastic stained with phosphor, and the microplastic analysis device performs a method including: irradiating a sample containing the microplastic with fluorescence excitation light and detecting fluorescent light emitted from the phosphor; specifying a position of the microplastic in the sample by the fluorescent light; irradiating the specified position with Raman excitation light and detecting Raman scattered light; and analyzing the microplastic at the specified position on a basis of the Raman scattered light.

By the way, in the case of analyzing an environmental sample such as earth and sand on a coast, it takes time and effort to bring the sample back from the collection site to a laboratory, to examine the presence or absence of microplastics, and to further examine physical properties and the like of the microplastics in more detail. In particular, in the case of investigation at many places, it is necessary to transport many samples.

In order to solve this problem, it is preferable to have a simple kit capable of immediately determining the presence or absence of a microplastic at a site where the sample is collected. That is because such a kit will provide the following benefits. For, example, in a case where only the presence or absence of the microplastic is examined, the result can be obtained only at the site, and in a case where it is desired to further examine the physical properties and the like of the microplastic by Raman spectroscopy or the like, it is only necessary to bring back only the sample in which a microplastic is confirmed to be present, thereby saving unnecessary time and effort of transportation.

To solve such a problem, the present invention may be a microplastic detection device including: a sample placement portion on which a sample containing a microplastic stained with phosphor is placed; a first light source that irradiates the sample placed on the sample placement portion with fluorescence excitation light; a camera holding portion that holds a portable camera at a position where the sample irradiated with the fluorescence excitation light is imaged; and an optical filter provided at a previous stage of the portable camera held by the camera holding portion, wherein the optical filter transmits the fluorescent light and blocks the fluorescence excitation light.

Such a device itself can be portable, and in addition, in a case where it is desired to leave a detection result as an image, it is only necessary to make a personal mobile phone having a camera, for example, be held on the camera holding portion, so that the microplastic in the sample can be easily detected at the collection site.

In addition, it is more preferable that the portable camera be equipped with a calculation unit that calculates a content rate of the microplastic in the sample from an occupancy area or the like of the microplastic shown in the image. The image data and the data including the content rate may be made capable of being transmitted by another device.

A microplastic detection method of the present invention includes: a sample placement step of placing a sample containing a microplastic stained with phosphor, on a predetermined sample placement portion; a light irradiation step of irradiating the sample placed on the sample placement portion with fluorescence excitation light; a camera holding step of holding a portable camera at a position where the sample irradiated with the fluorescence excitation light is imaged; an optical filter disposing step of disposing, on a previous stage of the portable camera, an optical filter that transmits the fluorescent light and blocks the fluorescence excitation light; and a step of capturing, with the camera, fluorescent light emitted from the microplastic in the sample.

Such a detection method can achieve the same operational effects as those of the above microplastic detection device of the present invention.

The microplastic detection method preferably includes further a staining step of staining the microplastic in the sample with the phosphor, the staining step including: immersing the sample in a staining liquid in which the phosphor is dissolved in a predetermined solvent; and then washing the sample with a cleaning liquid that removes the phosphor attached to a component other than the microplastic.

### Advantageous Effects of Invention

The present invention makes it possible to analyze a microplastic contained in a sample having a certain area in a short time by using Raman spectroscopy.

### BRIEF DESCRIPTION OF THE DRAWINGS

FIG. 1 is an overall schematic diagram of a Raman spectroscopic analyzer according to an embodiment of the present invention.

FIG. 2 is a flowchart illustrating a staining process of a microplastic in the embodiment.

FIG. 3 is a flowchart illustrating a Raman analysis process of a microplastic in a sample in the embodiment.

FIG. 4 is a flowchart illustrating a Raman analysis process of the microplastic in the sample in the embodiment.

FIG. 5 is a graph showing emission characteristics of Nile Red with respect to irradiation with excitation light of each wavelength in the embodiment.

FIG. 6 is a schematic sectional view of a microplastic detection device according to another embodiment of the present invention.

FIG. 7 is a schematic perspective view of the microplastic detection device according to the another embodiment of the present invention.

### REFERENCE SIGNS LIST

100 Raman spectroscopic analyzer (analysis device)
W sample
6 long-pass filter
42 short-pass filter

### DESCRIPTION OF EMBODIMENTS

Hereinafter, a Raman spectroscopic analyzer according to an embodiment of the present invention will be described with reference to the drawings.

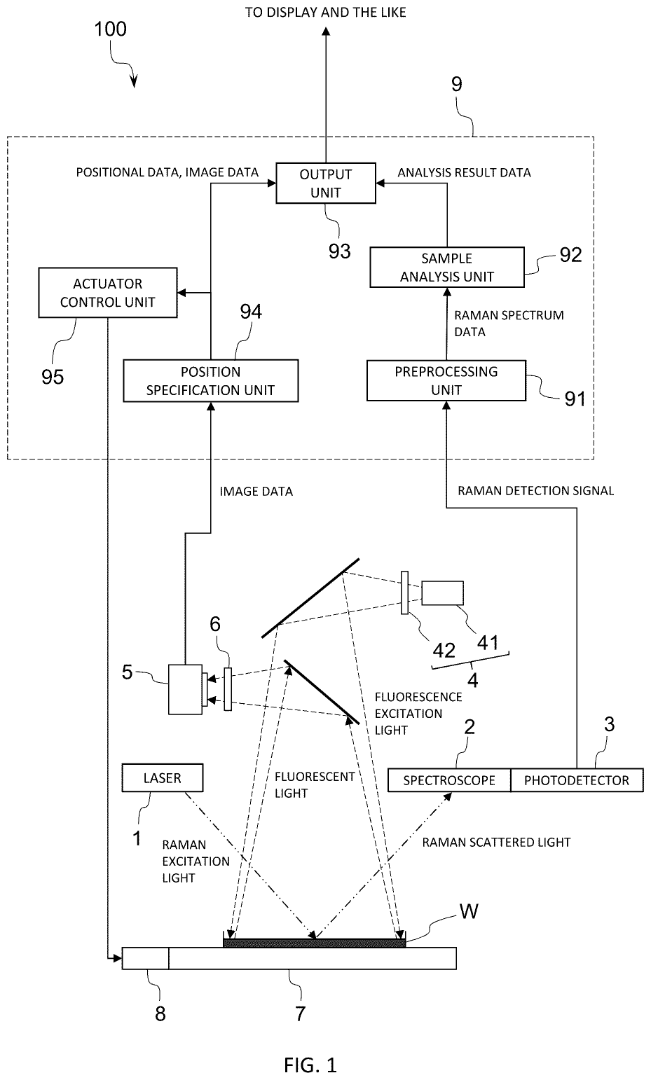

FIG. 1 is a schematic block diagram illustrating an overall configuration of a Raman spectroscopic analyzer 100 of the present embodiment.

In the drawing, reference numeral W denotes a sample. This sample is sand containing a microplastic that is collected at a coast. The sample W is put in a thin cell having a circular shape or a rectangular shape, and an analysis target region, which is a surface of the sample W, has a certain area.

Reference numeral 1 denotes a Raman light source that irradiates the surface of the sample W with Raman excitation light. In the present embodiment, a laser light source that emits monochromatic laser light (having a wavelength of about 785 nm) is used as the Raman light source 1, but the Raman light source 1 is not limited thereto.

Reference numeral 2 denotes a spectroscope that disperses Raman scattered light generated by application of the Raman excitation light. In the present embodiment, a grating is used as a spectroscope, but the spectroscope is not limited to a grating.

Reference numeral 3 denotes a photodetector that detects light of each wavelength dispersed by the spectroscope and outputs a Raman detection signal having a value corresponding to a detected light intensity for each wavelength. The photodetector 3 includes, for example, an optical sensor such as a CCD or a photomultiplier tube, and a signal converter that generates the Raman detection signals by performing, for example, impedance conversion processing or digitization processing on an output signal of the optical sensor.

Reference numeral 4 denotes a fluorescence excitation source that applies broad fluorescence excitation light whose upper limit wavelength is about 550 nm to the entire analysis target region of the surface of the sample W. The fluorescence excitation source 4 includes here a white LED 41 and an optical filter (short-pass filter 42) that is provided on an optical path of the white LED 41 and transmits light having a wavelength of about 550 nm or less. The upper limit of the wavelength of the fluorescence excitation source 4 is not limited to 550 nm, and is only required to be in the range of 400 nm to 600 nm. The fluorescence excitation light may be not only broad light but also light of a single wavelength emitted from an LED or the like. In that case, the optical filter is unnecessary.

Reference numeral 5 denotes a two-dimensional area sensor (here, CCD camera 5) that captures an image of the analysis target region of the sample W by one shot, and outputs image data of the analysis target region. At a previous stage of the CCD camera 5, there is disposed an optical filter (long-pass filter 6) that transmits light having a wavelength of about 625 nm or more. Note that the long-pass filter 6 only needs to transmit light having a wavelength of 600 nm to 700 nm or more.

Reference numeral 7 denotes an XYZ stage 7 as a moving mechanism that relatively moves an application position of the Raman excitation light on the sample W. The XYZ stage 7 can be moved in the horizontal X-Y direction by an actuator 8 such as a motor, and a cell in which the sample W is contained is placed on the XYZ stage 7.

Reference numeral 9 denotes an information processing device that receives the Raman detection signals output from the photodetector 3 and performs arithmetic processing on the Raman detection signals, thereby performing analysis and the like of the sample. The information processing device 9 is a so-called computer including a CPU, a memory, an I/O port, and the like, and the CPU and peripheral devices cooperate according to a program previously stored in the memory, thereby implementing functions as a preprocessing unit 91, a sample analysis unit 92, an output unit 93, and the like.

The preprocessing unit 91 receives the Raman detection signal for each wavelength from the photodetector 3, interpolates values of the Raman detection signals, in other words, interpolates light intensities for respective ones of wavelengths, and performs baseline correction, thereby generating Raman spectrum data that can be used for analysis.

The sample analysis unit 92 analyzes and specifies physical properties and the like of the sample W on the basis of the Raman spectrum data.

The output unit 93 outputs the analysis result obtained by the sample analysis unit 92, in a predetermined manner.

Furthermore, in the present embodiment, the information processing device 9 is made to have functions as a position specification unit 94 and an actuator control unit 95.

The position specification unit 94 receives the image data of the sample W from the CCD camera 5, processes the image data, for example, specifically performs binarization processing, thereby specify a position where fluorescent light is generated.

The actuator control unit 95 sends a command signal to the actuator 8 to move the XYZ stage 7 so that the Raman excitation light is applied to the position specified by the position specification unit 94.

Next, a description will be given on a procedure in which the microplastic in the sample W is analyzed by using the Raman spectroscopic analyzer 100 having the above configuration.

### Staining Process

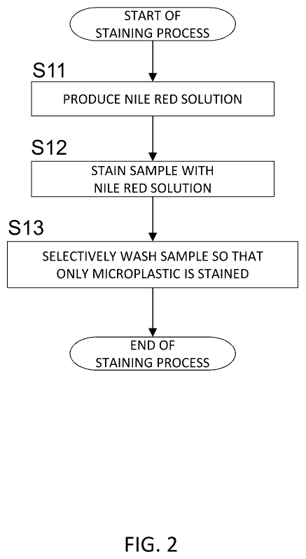

As shown in FIG. 2, first, Nile Red (C20H18N2O2), which is a lipid bilayer membrane type staining material, is dissolved in toluene as a solvent, to produce a Nile Red solution (step S11). Then, the sample W is immersed in the Nile Red solution (step S12). It is considered that, at this time, while the surface of the microplastic is slightly melted by toluene and Nile Red gets into the melted part, the other particles (glass, stone, and the like) receive almost no influence from toluene, and Nile Red is just adhered to the surface.

Next, the sample W is dried and then washed with ethanol (step S13). Since it is considered that Nile Red is merely attached to the surfaces of the other particles in the sample W, the Nile Red is washed off by this step, and only the microplastic is stained with Nile Red. As the cleaning liquid, a cleaning liquid that hardly dissolves the microplastic is preferable, and methanol or water may be used.

### Position Specification Process

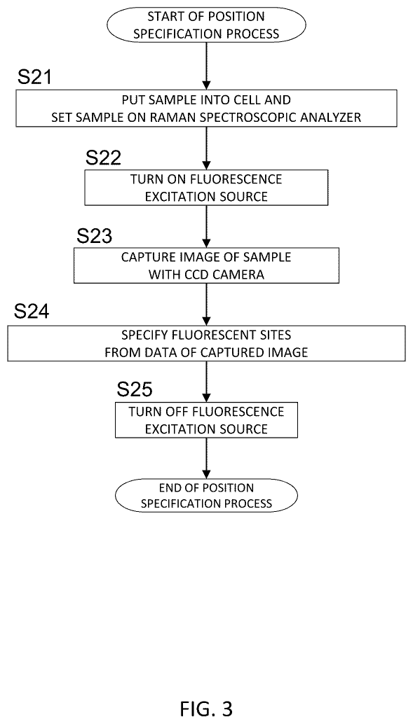

As illustrated in FIG. 3, the sample W, in which the microplastic is stained in the staining process, is put into a cell and is set in the Raman spectroscopic analyzer 100 (step S21).

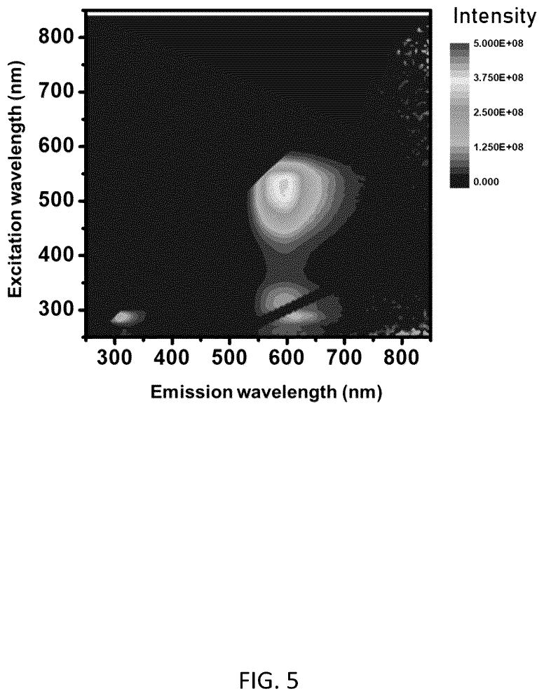

Then, the fluorescence excitation source 4 is turned on, the fluorescence excitation light is applied to the entire analysis target region of the surface of the sample W (step S22). Although Nile red is maximally excited by light at 553 nm, light having a wavelength from 400 nm to 600 nm can make Nile red emit sufficiently intense fluorescent light. Therefore, as in the present embodiment, fluorescent light is generated also by the fluorescence excitation light transmitted through the short-pass filter 42 that transmits light having a wavelength of 550 nm or less. The fluorescence wavelength spectrum of Nile Red with respect to the excitation light is as shown in FIG. 5, and the maximum fluorescence wavelength is generally said to be about 637 nm.

In this state, the CCD camera 5 images the entire analysis target region of the surface of the sample W (step S23). As described above, the long-pass filter 6 that transmits light having a wavelength of 625 nm or more is provided at the previous stage of the CCD camera 5. Since the fluorescent light has sufficient intensity also at a wavelength of 625 nm or more, the fluorescence is transmitted through the long-pass filter 6, and on the other hand, since the fluorescence excitation light has a wavelength of less than 550 nm, the fluorescence excitation light applied to the sample and scattered (Rayleigh scattered) by the sample is blocked by the long-pass filter 6. Therefore, the CCD camera 5 captures and images only the fluorescent light; therefore; in the image data obtained by imaging the sample W, only the fluorescent sites shine red and the other site is black (in the case of black and white, the fluorescent sites are white, and the other site is black.).

Next, the position specification unit 94 specifies sites in the sample where fluorescent light is emitted (hereinafter, the sites are also referred to as fluorescent sites), by performing binarization or the like on the image data, and stores positional data of the sites in the memory (step S24). At that time, the number, sizes, shapes, and the like of the fluorescent sites may also be stored.

Then, the fluorescence excitation source 4 is turned off.

### Raman Analysis Process

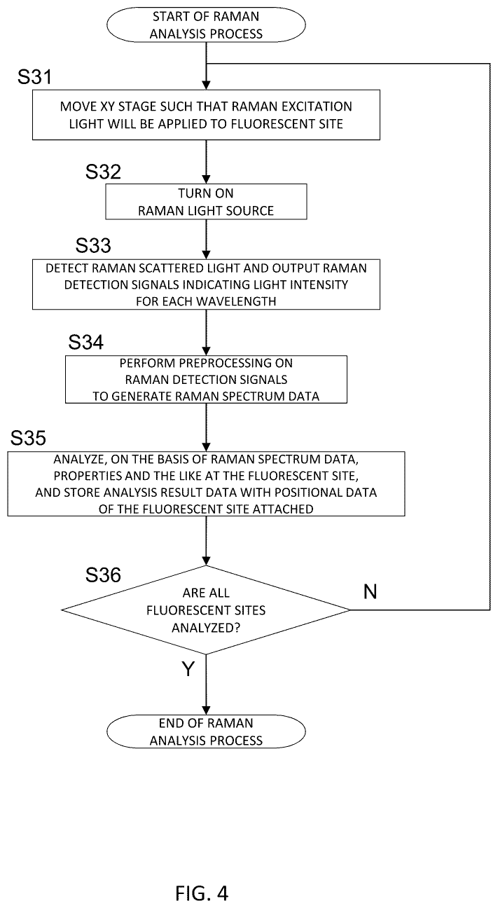

Next, as shown in FIG. 4, the actuator control unit 95 sends a command signal to the actuator 8 to move the XYZ stage 7 such that the Raman excitation light will be applied to the fluorescent site (step S31).

When the position of the sample is set in this manner, the Raman light source 1 is turned on, and the Raman excitation light is applied to the fluorescent site (step S32).

The Raman scattered light emitted from the fluorescent site is dispersed by the spectroscope 2 and output as a Raman detection signal indicating light intensity for each wavelength by the photodetector 3 (step S33).

Then, the preprocessing unit 91 receives the Raman detection signals and generates Raman spectrum data (step S34). On the basis of the Raman spectrum data, the sample analysis unit 92 analyzes physical properties and the like of the sample at the fluorescent site. The Raman spectrum data and the analysis data are stored in the memory in association with the positional data representing the fluorescent site (step S35).

This Raman analysis process is repeatedly performed until the entire range or the desired range of the fluorescent sites is analyzed (step S36).

As a result, the Raman spectrum data or the analysis data at each fluorescent site is acquired.

Note that, in this embodiment, the output unit 93 attaches the Raman spectrum data or the analysis data having the positional data, to the image data obtained by, for example, the CCD camera 5, and outputs the Raman spectrum data or the analysis data. When this data is subjected to arithmetic processing, the following operation and the like are possible. For example, when a fluorescent site of the sample image displayed on a screen is clicked, the composition of the microplastic or the Raman spectrum data at the site is displayed.

With the present embodiment configured as described above, mapping measurement by Raman or the like over the entire sample W is unnecessary, and Raman analysis only needs to be performed at necessary parts, so that the composition, type, and the like of microplastics contained in the sample W can be quickly analyzed. In addition, by a fluorescent light detection method of the present embodiment, since a minute microplastic on the order of 500 nm can also be detected, a spatial resolution by Raman analysis can be sufficiently utilized.

In addition, since toluene is used as a solvent of the phosphor solution (Nile Red solution) for staining, the staining takes only a few seconds, which can also contribute to shortening the analysis time. On the other hand, since toluene dissolves some types of plastics, there is a possibility that a microplastic having a minute size is melted and lost from the sample. In order to prevent this problem, an organic solvent, such as n-Hexane (normal hexane), may be used that has low dissolving power to plastics. However, in this case, staining may take a few hours in some cases.

Further, since the long-pass filter 6 that transmits the fluorescent light and blocks the fluorescence excitation light is provided in the previous stage of the CCD camera 5, only the fluorescent light can be reliably detected.

In addition, since the wavelength of the Raman excitation light is set to a wavelength of about 785 nm at which Nile Red cannot be excited, the influence of fluorescent light in the Raman analysis can also be eliminated.

Note that the present invention is not limited to the above embodiments.

For example, as the light source of the fluorescence excitation light, it is possible to use a broad wavelength light source such as a mercury lamp. Conversely, a monochromatic LED that emits light having a narrow wavelength may be used. In this case, the short-pass filter can be omitted depending on the selection of the monochromatic LED.

In the above embodiment, Nile Red is used as the phosphor, but the phosphor is not limited thereto. For example, any fluorescent substance may be used as the phosphor if the fluorescent substance can be dissolved in an organic solvent such as toluene, and for example, a commercially available fluorescent substance such as fluorescent choke may be used.

In the above embodiment, the sample W is put in a circular or rectangular thin cell, but the present invention is not limited thereto. In another embodiment, the sample W may be placed on a thin glass plate, an acrylic plate, or the like such that the analysis target region, which is the surface of the sample W, has a certain area. In this case, an adhesive member such as a double-sided tape may be provided on a placement surface for the sample W on the glass plate or the acrylic plate so that the placed sample W will not be displaced. Further, a scale may be provided on the placement surface for the sample W on the glass plate or the adhesive member on which the sample W is placed.

Although the type or the like of the microplastic cannot be specified, it is also possible to detect, only by fluorescent light, the fact that the microplastic is contained in the sample.

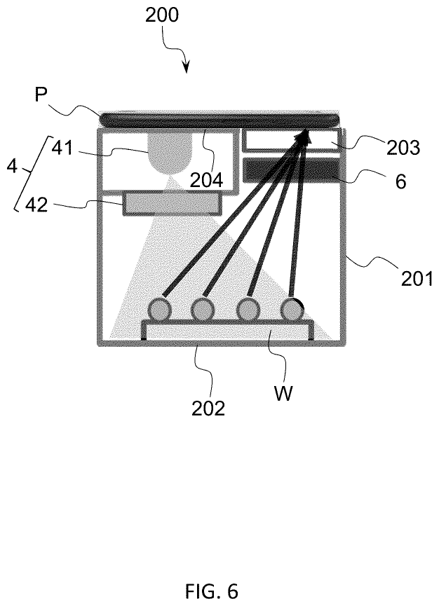

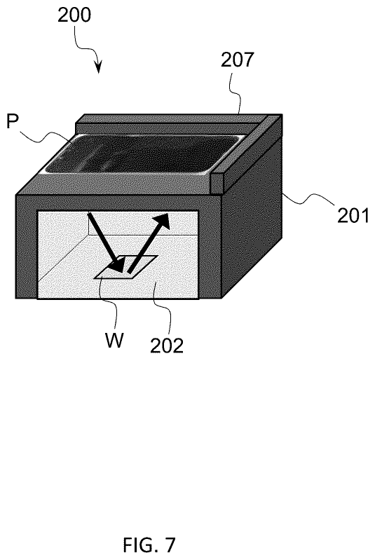

Specific examples thereof are illustrated in FIGS. 6 and 7.

The microplastic detection device 200 includes a housing 201 having a rectangular parallelepiped shape in a portable size and weight.

A sample placement portion 202 for placement of a sample W containing a microplastic stained with phosphor is provided on an upper surface of a bottom plate of the housing 201.

A fluorescence excitation source 4 including, for example, a green LED 41 and a short-pass filter 42 provided on one side of a lower surface of a housing upper plate, and fluorescence excitation light emitted from the fluorescence excitation source 4 is applied to the surface of the sample W placed on the sample placement portion 202. The green LED may alternatively be a white LED or the like. Further, for example, both a green LED and a white LED may be provided so that the light to be emitted can be switched between green and white. Instead of or in addition to providing a white LED, an openable and closable opening portion for taking in and out the sample W may be provided in the wall of the housing 201 so that light for observing the sample W can be taken into the housing 201 by opening the opening portion. In addition, the inner surface of the housing 201 may be coated with a light absorbing material or other measures may be taken so as to prevent irregular reflection of the fluorescence excitation light emitted from the fluorescence excitation source 4 in the housing 201.

In addition, to reduce uneven irradiation of the sample W with the fluorescence excitation light, a light diffusion member such as a diffusion plate, a diffusion sheet, or the like may be provided in front of the fluorescence excitation source 4 in the light emission direction and between the fluorescence excitation source 4 and the sample W.

In addition, to reduce uneven irradiation, the fluorescence excitation source 4 may be provided not only on the surface above the sample W but also on the side surface in the housing 201, and the sample W may be irradiated with the fluorescence excitation light from above and from the side.

Meanwhile, on the other side of a housing upper plate, there is opened a window 203, and a long-pass filter 6 that transmits fluorescent light but blocks the fluorescence excitation light similarly to the above embodiment is detachably or movably provided below the window 203 by an attachment and detachment mechanism (not illustrated).

On the upper surface of the housing upper plate, there is provided a camera holding unit 204 on which a smartphone P, which is a portable camera, is placed to be held. As illustrated in FIG. 6, the camera holding unit 204 has an L-shaped ridge 207 that is a positioning structure, and when the smartphone P is placed with its two sides in contact with the ridge 207, a camera surface of the smartphone P faces the window 203, so that the fluorescent light from the microplastic of the sample W can be imaged.

Such a microplastic detection device 200 itself is portable, and in a case where it is desired to leave a detection result as an image, it is only necessary to place the smartphone P on the camera holding unit 204, so that the microplastic in the sample can be easily detected at the collection site.

In addition, the long-pass filter 6 is detachable; therefore, when the long-pass filter 6 is detached, it is possible to capture a normal optical image, which is not emitting fluorescent light, of the sample W. In addition, since the imaging position of the smartphone P can always be set constantly only by matching the smartphone P to the ridges 207 of the camera holding unit 204, it is possible to capture a fluorescent image of the sample W and a normal optical image before and after attachment and detachment of the long-pass filter 6, in the same field of view. This makes it possible to easily display, in subsequent image processing, the optical image and the fluorescent image, for example, in an overlapping manner.

In addition, the smartphone P is more preferably mounted with a calculation unit (application) that calculates a content rate of the microplastic in the sample W from an occupancy area or the like of the microplastic shown in the image, because more information can be grasped at the site.

In addition, various modifications and combinations of embodiments may be made without being against the spirit of the present invention.

### INDUSTRIAL APPLICABILITY

The present invention described above makes it possible to analyze a microplastic contained in a sample having a certain area in a short time while using Raman spectroscopy.

1. A microplastic analysis method comprising:
staining a microplastic in a sample with phosphor;
irradiating the sample with fluorescence excitation light and detecting fluorescent light emitted from the phosphor;
specifying a position of the microplastic in the sample by the fluorescent light;
irradiating the specified position with Raman excitation light and detecting Raman scattered light; and
analyzing the microplastic at the position on a basis of the Raman scattered light.

2. The microplastic analysis method according to claim 1, wherein the staining a microplastic in a sample with phosphor includes:
immersing the sample in a staining liquid in which the phosphor is dissolved in a predetermined solvent;
then washing the sample with a cleaning liquid that can remove the phosphor attached to a component other than the microplastic.

3. The microplastic analysis method according to claim 2, wherein the phosphor includes Nile Red,
the solvent includes toluene, and
the washing liquid includes ethanol or methanol.

4. The microplastic analysis method according to claim 1, wherein the fluorescent light is detected by providing an optical filter that transmits the fluorescent light and blocks the fluorescence excitation light.

5. The microplastic analysis method according to claim 1, wherein a wavelength of the Raman excitation light is set to a wavelength that does not excite the phosphor.

6. A microplastic analysis device for a microplastic stained with phosphor, the microplastic analysis device performing a method comprising:
irradiating a sample containing the microplastic with fluorescence excitation light and detecting fluorescent light emitted from the phosphor;
specifying a position of the microplastic in the sample by the fluorescent light;
irradiating the specified position with Raman excitation light and detecting Raman scattered light; and
analyzing the microplastic at the position on a basis of the Raman scattered light.

7. A microplastic detection device comprising:
a sample placement portion on which a sample containing a microplastic stained with phosphor is placed;
a fluorescence excitation light source that irradiates the sample placed on the sample placement portion with fluorescence excitation light;
a camera holding portion that holds a portable camera at a position where the sample irradiated with the fluorescence excitation light can be imaged; and
an optical filter provided at a previous stage of the portable camera held by the camera holding portion, wherein the optical filter transmits the fluorescent light and blocks the fluorescence excitation light.

8. A microplastic detection method comprising:
a sample placement step of placing a sample containing a microplastic stained with phosphor, on a predetermined sample placement portion;
a light irradiation step of irradiating the sample placed on the sample placement portion with fluorescence excitation light;
a camera holding step of holding a portable camera at a position where the sample irradiated with the fluorescence excitation light can be imaged;
an optical filter disposing step of disposing, on a previous stage of the portable camera, an optical filter that transmits the fluorescent light and blocks the fluorescence excitation light; and
a step of capturing, with the camera, fluorescent light emitted from the microplastic in the sample.

9. The microplastic detection method according to claim 8, further comprising a staining step of staining the microplastic in the sample with the phosphor, the staining step including:
immersing the sample in a staining liquid in which the phosphor is dissolved in a predetermined solvent; and
then washing the sample with a cleaning liquid that can remove the phosphor attached to a component other than the microplastic.
